(19) United States
(12) Patent Application Publication
(10) Pub. No.: US 2026/0132311 A1
(43) Pub. Date: May 14, 2026

(54) PHOTOCURABLE ADHESIVE COMPOSITION AND CURED ADHESIVE FORMED THEREFROM

(71) Applicant: University of Massachusetts, Westborough, MA (US)

(72) Inventors: Alfred J. Crosby, Amherst, MA (US); Gabriela Moreira Lana, Amherst, MA (US)

(21) Appl. No.: 19/387,756

(22) Filed: Nov. 13, 2025

Related U.S. Application Data
(60) Provisional application No. 63/719,838, filed on Nov. 13, 2024.

(51) Int. Cl. C09J 4/06; C09J 5/00

(52) U.S. Cl. CPC C09J 4/06; C09J 5/00; C09J 2301/408; C09J 2301/416; C09J 2409/006; C09J 2423/046; C09J 2453/00; C09J 2475/006

(57) ABSTRACT

A photocurable adhesive composition includes a ABA triblock copolymer, a polymerizable monomer, a photoinitiator, and optionally, a crosslinker. The A blocks of the copolymer are capable of forming rigid domains upon self-assembly, and the B block form a soft matrix. The polymerizable monomer is selected to selectively solubilize the B block of the triblock copolymer. Advantageously, the photocurable adhesive composition can be solvent-free. The photocurable adhesive composition can form a cured adhesive when exposed to ultraviolet radiation. The cured adhesive is capable of bonding surfaces, including fabric substrates.

### CROSS-REFERENCE TO RELATED APPLICATION

This application claims priority to U.S. Provisional Patent Application No. 63/719,838, filed on Nov. 13, 2024, the contents of which are hereby incorporated by reference herein in their entirety.

### BACKGROUND

Adhering soft, flexible materials, such as fabrics and multilayered composites, presents unique challenges due to their surface topography, porosity, and the need to maintain mechanical properties under large deformations. Conventional solutions, such as seam tapes, often use hot-melt adhesives, which can be too stiff and lead to poor mechanical integration with the substrate under deformation. Similarly, solvent-based adhesives rely on the use of multiple solvents to wet and penetrate the substrate, but they introduce lengthy evaporation times and environmental and health concerns. Without solvents, poor penetration can lead to delamination or stress concentrations at the joint, ultimately causing poor adhesion and joint failure. Sewing is another common approach, but it introduces failure points at the needle holes and requires complex machinery, limiting durability.

Thus, there is a need for innovative adhesive systems that offer strong, flexible, and durable bonds without relying on solvents or stitching.

### SUMMARY

An aspect of the disclosure is a photocurable adhesive composition comprising: an ABA triblock copolymer, wherein the A blocks are capable of self-assembling into rigid domains and the B block provides a soft matrix; a polymerizable monomer capable of selectively solubilizing the B block of the ABA triblock copolymer; a photoinitiator capable of initiating polymerization when irradiated with ultraviolet light; and optionally, a crosslinker.

Another aspect is a cured adhesive formed from the photocurable adhesive composition.

Another aspect is a method of bonding, the method comprising: applying the photocurable adhesive composition to at least a portion of a surface of a first substrate; affixing the first substrate to a second substrate; and exposing the photocurable adhesive composition to ultraviolet radiation to initiate curing.

The above described and other features are exemplified by the following figures and detailed description.

### BRIEF DESCRIPTION OF THE DRAWINGS

The following figures are exemplary embodiments.

FIG. 1 shows a schematic representation of the ABA triblock copolymer poly(methyl methacrylate)-block-poly(n-butyl acrylate)-block-poly(methyl methacrylate) (PMMA-b-PnBA-b-PMMA) that self-assembles when dissolved in the butyl acrylate monomer. Upon addition of initiator, photopolymerization under ultraviolet (UV) forms a secondary network of poly(n-butyl-acrylate) (PnBA), locking the domains in place and enhancing mechanical properties of the material.

FIG. 2 shows gel permeation chromatography (GPC) traces of polymerized samples without crosslinker, with different initiator content (1% or 2%) and UV exposure time (15 or 30 minutes (min)), in comparison to the neat triblock.

FIG. 3 shows Fourier Transform Infrared (FTIR) spectra of samples with varying initiator before and after UV, indicating complete reaction of the double bonds after photopolymerization.

FIG. 4 shows small angle X-ray scattering (SAXS) profiles for the triblock compared to adhesive formulations with 0 mole percent (mol %), 5 mol % and 10 mol % crosslinker.

FIG. 5 shows transmission electron microscopy (TEM) images of adhesive formulation samples, overview (top) and close-up (bottom).

FIG. 6 shows dynamic mechanical analysis (DMA) frequency sweep results for samples without crosslinker, showing the effect of varying initiator content (1 mol % and 2 mol %) and UV exposure time (15 and 30 min), compared to the neat triblock.

FIG. 7 shows DMA frequency sweep results for samples with different crosslinker contents (0 mol %, 2.5 mol %, 5 mol %, and 10 mol %), compared to the neat triblock. All presented samples were exposed to UV for 15 min.

FIG. 8 shows representative stress-strain curves from tensile tests on the bulk films, illustrating the mechanical response as function of crosslinker content and UV exposure time.

FIG. 9 shows Tangent modulus calculated from the tensile tests at low and high strains, plotted against varying crosslinker contents.

FIG. 10 shows stress x strain curve for the formulations exposed to UV for 15 min, compared to the pristine neoprene fabric substrate.

FIG. 11 shows failure stress and strain at failure for the following configurations: (1) single piece of pure neoprene substrate without any adhesive (control), two pieces of neoprene: (2) bonded at the center using the adhesive as glue, (3) bonded along the exterior edges using the adhesive as a seam, (4) bonded with both glued center and external seam application of the adhesive (glue+seam), and (5) sewn together, representing current conventional attachment methods (sewn). The results highlight the effectiveness of our acrylate-based adhesive in providing a strong, stretchable bond comparable to traditional sewing techniques.

FIG. 12 shows photographs of the joints glue+seam and sewn, shortly before they start to fail under tensile strain. Arrow indicates point of failure initiation caused by sewing puncture.

FIG. 13 shows stress-strain curves for formulations exposed to UV for 30 seconds, 1 minutes, and 15 minutes.

FIG. 14 shows Tangent modulus calculated from the tensile tests, plotted against UV cure time.

FIG. 15 shows stress-strain curves for formulations comprising a bio-based ABA triblock copolymer according to an aspect.

### DETAILED DESCRIPTION

Biological materials such as tendons and spider silk illustrate how gradients in mechanical properties, combined with different networks and hierarchical microstructures, can bind components with varying stiffness, ensuring effective load transfer without compromising flexibility. Tendons serve as transition structures between stiff bone and soft muscle, distributing mechanical forces while maintaining both strength and compliance. Their primary structural component is a collagen network, which provides strength and mechanical resistance, while the dense connective tissue that surrounds the collagen fibers allows for the tendon's stretchability. Another example is dragline spider silk, which features a hierarchical structure of stiff nanocrystalline P-sheets embedded within a softer amorphous protein matrix, enabling it to combine both robustness and elasticity. Similarly, the present adhesives with dual functionality provide strength and stretchability by matching the mechanical properties of the adhesive and substrate through a combination of strategies: using a dual-network that combines physical and chemical crosslinks, and self-assembly into a high order architecture.

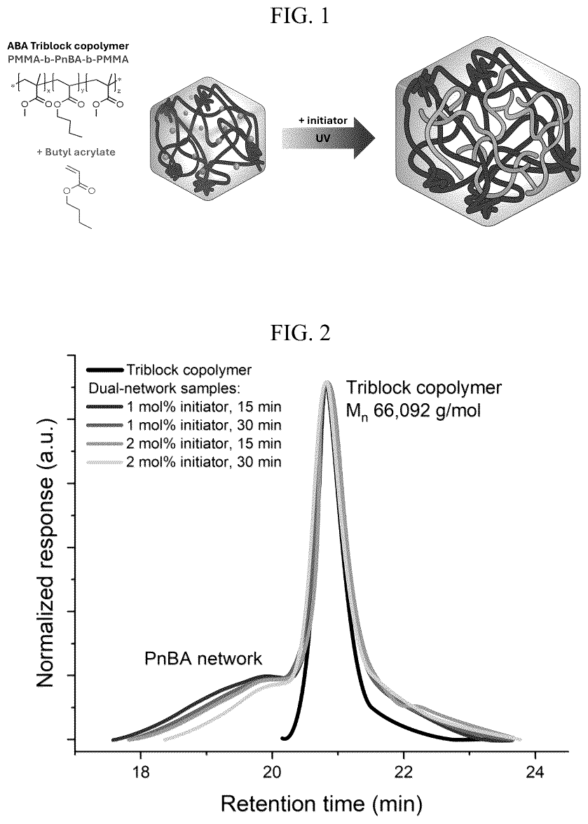

In particular, the present inventors have developed a solvent-free dual-network adhesive using a self-assembling triblock copolymer network and a secondary network polymerized in situ, to achieve high strength and stretchability. In an exemplary aspect, the present system includes an ABA triblock copolymer, for example having end blocks that assemble into rigid domains, and a mid-block that forms a soft, elastic matrix. A second network can be formed through in situ photo-polymerization of a polymerizable monomer, which serves as a mid-block selective solvent. This polymerization locks the rigid domains in place, creating a load-bearing system capable of reversible deformation and strain amplification. A schematic illustration of an ABA triblock copolymer self-assembling when dissolved in the monomer, and photopolymerization to form a secondary network is shown in FIG. 1.

Adjusting the crosslinking density of the secondary network provides the ability to tailor the adhesive's mechanical properties to suit different substrates. This tunability allows the adhesive to bond challenging materials, such as neoprene fabric composites, which require flexibility and strength under large deformations. Unlike traditional adhesives, the present system eliminates the need for solvents, offering an eco-friendly and efficient solution that can be directly applied to the substrate. A significant improvement is therefore provided by the present disclosure.

Accordingly, an aspect of the present disclosure is a photocurable adhesive composition. The photocurable adhesive composition comprises an ABA triblock copolymer (also referred to herein as “the copolymer”).

The ABA triblock copolymer is selected such that the A end blocks are capable of self-assembling into rigid domains, while the B midblock provides a soft, flexible matrix. In some aspects, the “hard” segments (e.g., the A blocks) can have a glass transition temperature of 40 to 200° C., or 50 to 175° C., or 75 to 165° C., or 85 to 165° C., or 100 to 120° C. Glass transition temperature of the A block refers to an isolated A block copolymer (i.e., not incorporated into the block copolymer). Glass transition temperature can be determined, for example, using differential scanning calorimetry. In some aspects, the “soft” segments (e.g., the B block) can have a glass transition temperature that is less than the glass transition temperature of the A blocks. For example, the B block can have a glass transition temperature of −75 to 25° C., or −65 to 25° C. or −65 to 0° C., or −65 to −10° C., or −50 to −40° C.

In an aspect, the ABA triblock copolymer can comprise A blocks comprising a poly(C₁₋₃ alkyl) methacrylate and a B block comprising a poly(C₄₋₁₂ alkyl) methacrylate. For example, each A block can comprise poly(methyl methacrylate), poly(ethyl methacrylate), or poly(isopropyl methacrylate), and the B block comprise a poly(butyl methacrylate), a poly(hexyl methacrylate), a poly(ethylhexyl methacrylate), or poly(dodecyl methacrylate).

In a specific aspect, the A blocks of the ABA triblock copolymer can each comprise a poly(methyl methacrylate). In a specific aspect, the B block of the ABA triblock copolymer can comprise poly(n-butyl acrylate). Thus in some aspects, the ABA triblock copolymer can be a poly(methyl methacrylate)-b-poly(n-butyl acrylate)-b-poly(methyl methacrylate) triblock copolymer.

In another exemplary aspect, the A blocks of the ABA triblock copolymer can each comprise a poly(alkenyl aromatic), for example poly(styrene), and the B block can comprise a polyolefin, such as butadiene or isoprene. The ABA triblock copolymer derived from the alkenyl aromatic and olefin can be hydrogenated or unhydrogenated. In some aspects, the ABA triblock copolymer can be a poly(styrene)-b-poly(butadiene)-b-poly(styrene) block copolymer or a poly(styrene)-b-poly(isoprene)-b-poly(styrene) block copolymer.

In an aspect, the ABA triblock copolymer can be a hydrogenated block copolymer, wherein the A blocks of the ABA triblock copolymer can each comprise a poly(styrene), and the B block can comprise a hydrogenated polyolefin. As used here, the term hydrogenated polyolefin refers to the unsaturated group content of the B block being at least partially reduced by hydrogenation. Exemplary hydrogenated ABA triblock copolymers can include, but are not limited to, polystyrene-poly(ethylene-butylene)-polystyrene triblock copolymers, polystyrene-poly(ethylene-ethylene/propylene)-polystyrene triblock copolymers.

In an aspect, at least a portion of the repeating units of the ABA triblock copolymer can be derived from a bio-based monomer (i.e., based on natural or renewable resources). In some aspects, the ABA triblock copolymer can have a bio content of at least 50%, or at least 60%, or at least 70%, or at least 80%. In some aspects, the biobased ABA triblock copolymer can have a styrene content of 15 to 25 weight percent, based on the total weight of the ABA triblock copolymer.

In a specific aspect, the A blocks of the ABA triblock copolymer can each comprise a poly(styrene), and the B block can comprise a repeating units derived from farnesene, for example beta-farnesene. Exemplary bio-based ABA triblock copolymers include those commercially available under the tradename SEPTON, from Kuraray. In such commercially available materials, the farnesene monomer can be derived from sugarcane or other biorenewable sources.

In some aspects, the ABA triblock copolymer can have an A block content of 10 to 50 weight percent, or 15 to 40 weight percent, or 20 to 40 weight percent, or 25 to 35 weight percent, and a B block content of 50 to 90 weight percent, or 60 to 85 weight percent, or 60 to 80 weight percent, or 65 to 75 weight percent, each based on total weight of the triblock copolymer. In some aspects, the triblock copolymer can have an overall number average molecular weight of 20,000 to 100,000 grams per mole, or 40,000 to 80,000 grams per mole, or 50,000 to 70,000 grams per mole, or 55,000 to 70,000 grams per mole, or 60,000 to 70,000 grams per mole.

Exemplary ABA triblock copolymers that may be useful in the photocurable adhesive composition of the present disclosure can include those commercially available under the tradename KURARITY™ or the SEPTON™ BIO-series from Kuraray.

The ABA triblock copolymer can be present in the photocurable adhesive composition in an amount of 10 to 50 weight percent, based on the total weight of the photocurable adhesive composition. For example, the ABA triblock copolymer can be present in an amount of 15 to 45 weight percent, or 20 to 40 weight percent, or 25 to 40 weight percent, or 30 to 40 weight percent, each based on the total weight of the photocurable adhesive composition.

In addition to the ABA triblock copolymer, the photocurable composition comprises a polymerizable monomer. The polymerizable monomer is selected such that it is capable of selectively solubilizing the B block of the ABA triblock copolymer. Stated another way, the A blocks of the ABA triblock copolymer are substantially insoluble in the polymerizable monomer.

The polymerizable monomer comprises a polymerizable functional group, preferably that is capable of polymerization by free-radical polymerization techniques. In some aspects, the polymerizable functional group comprises ethylenic unsaturation, for example an alkenyl group, an acrylate, a methacrylate, an acrylamide, a methacrylamide, or the like. In a specific aspect the polymerizable functional group is an acrylate. In some aspects, the polymerizable monomer can be selected to match the identity of the repeating units of B block of the triblock copolymer. For example, in a specific aspect, the polymerizable monomer can be n-butyl acrylate, particularly when the B block of the ABA triblock copolymer comprises repeating units derived from n-butyl acrylate. In another aspect, for example when the B block comprises a polyolefin (e.g., poly(butadiene), poly(isoprene), poly(ethylene-butylene), poly(ethylene-propylene), or the like), the polymerizable monomer can comprise an olefin, such as butadiene or isoprene.

The polymerizable monomer can be present in the photocurable adhesive composition in an amount of 40 to 80 weight percent, based on the total weight of the photocurable composition. For example, the polymerizable monomer can be present in the photocurable adhesive composition in an amount of 40 to 70 weight percent, or 40 to 65 weight percent, or 45 to 65 weight percent, each based on the total weight of the photocurable adhesive composition.

In addition to the ABA triblock copolymer and the polymerizable monomer, the photocurable adhesive composition comprising a photoinitiator capable of initiating polymerization of the polymerizable monomer with irradiated with ultraviolet light. In an aspect, the photoinitiator can be a photoradical generator. As used herein, a “photoradical generator” refers to a polymerization initiator that can generate a radical when induced by light (e.g., infrared light, visible light, ultraviolet light, far-ultraviolet light, an X-ray, or a charged particle beam, such as an electron beam). Photoradical generators can therefore generate a radical in a chemical reaction caused by photoirradiation and initiate a radical polymerization. In an aspect, photoradical generators which generate a radical in response ultraviolet (UV) can be preferred.

Exemplary photoradical generators can include, but are not limited to, substituted or unsubstituted 2,4,5-triarylimidazole dimers (e.g., 2-(o-chlorophenyl)-4,5-diphenylimidazole dimer, 2-(o-chlorophenyl)-4,5-di(methoxyphenyl)imidazole dimer, 2-(o-fluorophenyl)-4,5-diphenylimidazole dimer, 2-(o- or p-methoxyphenyl)-4,5-diphenylimidaole dimer, and the like); benzophenone and derivatives thereof (e.g., N,N′-tetramethyl-4,4′-diaminobenzophenone (Michler's ketone), N,N′-tetraethyl-4,4′-diaminobenzophenone, 4-methoxy-4-dimethylaminobenzophenone, 4-chlorobenzophenone, 4,4′-dimethoxybenzophenone, 4,4′-diaminobenzophenone, and the like); aromatic ketone derivatives (e.g., 2-benzyl-2-dimethylamino-1-(4-morpholinophenyl)-butanone-1,2-methyl-1-4-(methylthio)phenyl-2-morpholino-propanon-1-one); quinones (e.g., 2-ethylanthraquinone, phenanthrenequinone, 2-t-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoduinone, 9,10-phenanthrenequinone, 2-methyl-1,4-naphthoduinone, 2,3-dimethylanthraquinone, and the like); benzoin ether derivatives (e.g., benzoin methyl ether, benzoin ethyl ether, benzoin phenyl ether, and the like); benzoin and benzoin derivatives (e.g., methyl benzoin, ethylbenzoin, propylbenzoin, and the like); benzyl derivatives (e.g., benzyl dimethyl ketal); acridine derivatives (e.g., 9-phenylacridine and 1,7-bis(9,9′-acridinyl)heptane); N-phenylglycine and N-phenylglycine derivatives; acetophenone and acetophenone derivatives (e.g., 3-methylacetophenone, acetophenone benzyl ketal, 1-hydroxycyclohexyl phenyl ketone, and 2,2-dimethoxy-2-phenylacetophenone); thioxanthone and thioxanthone derivatives (e.g., diethylthioxanthone, 2-isopropylthioxanthone, and 2-chlorothioxanthone); and phosphine oxides (e.g., phenylbis(2,4,6-trimethylbenzoyl)phosphine oxide, and bis-(2,6-dimethoxybenzoyl)-2,4,4-trimethylpentylphosphine oxide). Combinations comprising any of the foregoing photoradical generators can be used.

In an aspect, the photoradical generator can comprise a bisacylphosphine oxide. Phenylbis(2,4,6-trimethylbenzoyl)phosphine oxide can be preferred.

In an aspect, the photoinitiator can absorb light in the range of 200 to 400 nanometers, preferably 300 to 400 nanometers.

The photoinitiator can be present in the photocurable adhesive composition in an amount of 0.05 to 5 weight percent, based on the total weight of the photocurable adhesive composition. For example, the photoinitiator can be present in the photocurable adhesive composition in an amount of 0.1 to 5 weight percent, or 0.5 to 5 weight percent, or 1 to 5 weight percent, or 2 to 4 weight percent, each based on the total weight of the photocurable adhesive composition.

In addition to the ABA triblock copolymer, the polymerizable monomer, and the photoinitiator, the photocurable adhesive composition can optionally further comprise a crosslinker. When present, the crosslinker is not particularly restricted provided that it contains two or more reactive groups capable of reacting with the polymerizable group of the polymerizable monomer. For example, a crosslinker can comprise two or more free radically polymerizable groups.

Preferably, the crosslinker comprises at least two free radically polymerizable groups, for example comprising ethylenic unsaturation. In an aspect, the crosslinker can comprise at least two (meth)acrylate groups. For example, suitable crosslinkers can include those according to the formula

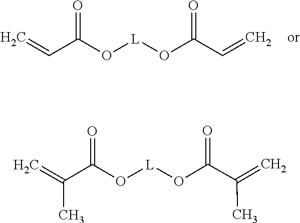

wherein L is a linking group, for example a C₁₋₁₂ alkylene linking group, a C₁₋₁₂ alkylene oxide linking group, or a poly(C₁₋₆ alkylene oxide) linking group. In a specific aspect, when present, the crosslinker can comprise a glycol dimethacrylate, preferably ethylene glycol dimethacrylate (i.e., wherein L is —C₂H₄—).

When present, the crosslinker can be included in the photocurable adhesive composition in an amount of greater than 0 to 20 weight percent, based on the total weight of the photocurable adhesive composition. For example, the crosslinker can be included in the photocurable adhesive composition in an amount of 1 to 20 weight percent, or 1 to 18 weight percent, or 1 to 15 weight percent, or 2 to 18 weight percent or 2 to 15 weight percent, or 1 to 12 weight percent, or 1 to 10 weight percent, each based on the total weight of the photocurable adhesive composition.

In a specific aspect, the photocurable adhesive composition can comprise 20 to 40 weight percent of the ABA triblock copolymer; 40 to 80 weight percent of the polymerizable monomer; 0.05 to 5 weight percent of the photoinitiator; and 0 to 20 weight percent of the crosslinker; wherein weight percent of each component is based on the total weight of the composition.

In another specific aspect, the photocurable adhesive composition can comprise 20 to 40 weight percent of the ABA triblock copolymer; 40 to 80 weight percent of the polymerizable monomer; 0.05 to 5 weight percent of the photoinitiator; and 2 to 20 weight percent of the crosslinker; wherein weight percent of each component is based on the total weight of the composition.

In some aspects, the ABA triblock copolymer can be a poly(methyl methacrylate)-b-poly(n-butyl acrylate)-b-poly(methyl methacrylate) triblock copolymer; the polymerizable monomer can comprise n-butyl acrylate; the photoinitiator can be a photoradical generator capable of absorbing light in the range of 300 to 400 nanometers; and when present, the crosslinker can comprise at least two free-radically polymerizable groups, preferably (meth)acrylate groups.

It will be understood that the amount of each component of the composition is selected such that the total amount of the components sums to 100 weight percent.

The photocurable adhesive composition can be free of any component not specifically provided for herein. Advantageously, the photocurable adhesive composition can be substantially free of a solvent, for example an organic solvent. For example, the photocurable adhesive composition can comprise less than 5 weight percent, or less than 1 weight percent, or less than 0.1 weight percent, or exclude a solvent. In some aspects, polymers other than the ABA triblock copolymer may be excluded from the photocurable composition.

The photocurable adhesive composition of the present disclosure can be in the form of a homogenous liquid. In an aspect, the photocurable adhesive composition can have a viscosity of 25,000 to 45,000×10³ centipoise (cps), for example 30,000 to 40,000×10³ cps. Advantageously, the viscosity of the photocurable adhesive composition can be tuned by careful selection of the particular components of the composition. Formulating a composition having a particular viscosity can be desired for tuning the depth of penetration into a substate (e.g., a substrate to be bonded). Suitable penetration depth may vary based on the substrate. The liquid photocurable composition is also well-suited for use in additive manufacturing processes or other automated deposition methods.

A cured adhesive formed from the photocurable adhesive composition represents another aspect of the present disclosure. The cured adhesive can be formed by exposing the photocurable adhesive composition of the present disclosure to ultraviolet radiation under conditions effective to initiate curing. For example, exposing the photocurable adhesive composition to ultraviolet radiation can be at room temperature (e.g., 20 to 30° C.), and can be for 30 seconds to 1 hour, for example 1 minute to 1 hour, 1 to 30 minutes or 1 to 15 minutes to provide the cured composition.

The cured composition can comprise a plurality of rigid domains derived from the A block of the ABA triblock copolymer dispersed in a soft, elastic matrix comprising the B midblock of the ABA triblock copolymer and the polymer derived from polymerization of the polymerizable monomer and optionally, the crosslinker. In some aspects, the cured composition can comprise a plurality of rigid domains having an average diameter of 2 to 25 nanometers, with a spacing between rigid domains of 10 to 30 nanometers. As further discussed in the working examples below, the resulting morphology of the cured composition can depend on factors including, but not necessarily limited to, crosslinker concentration, relative concentrations of the ABA triblock copolymer and polymerizable monomer, and weight fractions of the A and B block of the copolymer.

The cured adhesive can exhibit desirable properties, including a Young's modulus of 0.15 to 1.2 MegaPascals (MPa), for example 0.17 to 1.18 MPa. The cured adhesive can also exhibit a stretchability of at least 50%, for example 50% to greater than 250% in some instances. Material properties and the relationship to formulation (e.g., crosslinker concentration) is further discussed in the working examples below.

The photocurable adhesive compositions described herein can be particularly useful in bonding various substrates. Accordingly, a method of bonding represents another aspect of the present disclosure. The method comprises applying the photocurable adhesive composition to at least a portion of a surface of a first substrate, and affixing the first substrate to the a second substrate. In some aspects, the method can comprise arranging the first substrate and the second substrate, for example in an end-to-end arrangement or in a juxtapositional relationship, or an overlapping arrangement, and applying the photocurable adhesive composition to form a seam between the first and second substrate. The method further comprises exposing the photocurable adhesive composition to ultraviolet radiation to initiate curing and form the cured adhesive composition. The wavelength of light can be selected to activate the photoinitiator, and in a specific aspect, can include light at a wavelength in the range of 300 to 400 nanometers.

The photocurable adhesive composition can be applied in a manner effective to bond the substrates, and as shown in the examples provided herein, in some instances the application of the photocurable adhesive composition can affect the strength of the bond between the two substrates. For example, in some aspects the cured adhesive can be disposed between two edges of the substrates. In some aspects, the cured adhesive can be applied over two adjacent edges of the substrates to form a seam. A combination of forming the seam and the gluing the edges of the substrates can also be used.

Each of the first and second substrates are not particularly limited, and may be the same or different. For example, the substrate can be flexible or inflexible and can be formed from a polymeric material, glass or ceramic material, metal, or combination thereof. Some substrates are polymeric films such as those prepared from polyolefins (e.g., polyethylene, polypropylene, or copolymers thereof), polyurethanes (e.g., thermoplastic polyurethanes), polyvinyl acetates, polyvinyl chlorides, polyesters (polyethylene terephthalate or polyethylene naphthalate), polycarbonates, polymethyl(meth)acrylates (PMMA), ethylene-vinyl acetate copolymers, and cellulosic materials (e.g., cellulose acetate, cellulose triacetate, and ethyl cellulose). Other substrates are metal foils, nonwoven materials (e.g., paper, cloth, nonwoven scrims), foams (e.g., polyacrylic, polyethylene, polyurethane, neoprene), and the like. In some aspects, the first and second substrates can each comprise a flexible fabric. As used herein, the term “flexible fabric” a sheet, film, woven, or nonwoven substrate formed predominantly of the indicated polymeric material (e.g., neoprene, polyurethane (PU), thermoplastic polyurethane (TPU), ethylene-vinyl acetate (EVA), or the like), optionally including fillers, fibers, or additives that do not materially affect its flexibility or other desired properties. In some aspects, the first and second substrates can be a laminate comprising more than one layer, or may be a composite or blend, for example comprising other polymeric or fibrous materials. For example is some aspects, the substrate may comprise a flexible fabric substrate optionally having a backing layer disposed thereon, which may be, for example, a polymeric film.

For some substrates, it may be desirable to treat the surface to improve adhesion to the crosslinked composition. Such treatments include, for example, application of primer layers, surface modification layer (e.g., corona treatment or surface abrasion), or both.

In some aspects, the first and second substrates can each independently comprise a woven or nonwoven polymeric fabric or a substantially elastic composite film. In an aspect first and second substrates can each independently comprise neoprene.

It will also be understood that in some aspects, it may be desirable to bond more than two substrates to form, for example, a multilayer composite.

Thus the present inventors have discovered a dual network composition further including high-order structuring to provide an adhesive composition having tunable properties, and advantageously capable of matching properties of soft, stretchable substrates. The chemically crosslinked network derived from the polymerizable monomer adds resistance to failure, and complements the triblock copolymer which is self-assembled into stiff microdomains creating a physically crosslinked network, resulting in a strong, stretchable adhesive, without the use of a solvent. A significant improvement is therefore provided by the present disclosure.

This disclosure is further illustrated by the following examples, which are non-limiting.

### EXAMPLES

For the following examples, neoprene fabric was selected to demonstrate the performance of the adhesive system that can be applied without solvents and have the formulation tuned to match the mechanical response of the substrate, providing good adhesion and barrier properties. Neoprene fabric is a fabric-based, multi-layered composite used in a wide range of applications, including sports apparel, medical devices, fashion and footwear, industrial gaskets and seals, marine equipment, military gear, and soundproofing panels. In all these applications, the present adhesive offers an innovative, eco-friendly, and efficient solution, eliminating the need for solvents while ensuring excellent flexibility, strength, and durability.

The adhesive formulation was prepared by dissolving the ABA triblock copolymer (poly(methyl methacrylate))-b-(poly(n-butyl acrylate))-b-(poly(methyl methacrylate)) (PMMA-b-PnBA-b-PMMA) pellets in the n-butyl acrylate (BA) monomer, which served as a midblock-selective solvent. Addition of photo-initiator (phenylbis(2,4,6-trimethylbenzoyl)phosphine oxide, Irgacure 819) and, for some samples, a crosslinker (ethylene glycol dimethacrylate, EGDMA) enable the in situ polymerization of BA into a PnBA network. Samples were polymerized under UV irradiation (7.5-9 mW/cm²) for 5, 15 or 30 minutes. The initial mixture consisted of 60 wt % BA and 40 wt % triblock copolymer. Triblock concentrations above 40 wt % were not characterized for mechanical and adhesion properties due to a significant increase in solution viscosity, which impaired handling and application.

To verify the BA polymerization within the triblock structure, gel permeation chromatography (GPC) and Fourier transform infrared spectroscopy (FTIR) were performed on samples without any crosslinker, but with varying initiator content (1 mol % and 2 mol % of the number of vinyl groups) and UV exposure times (5, 15, and 30 minutes). Specific weight fraction of the components is reported in Table 1.

TABLE 1

| | | ABA triblock | BA | EGDMA | Initiator |
|---|---|---|---|---|---|
| Sample | Description | (wt. fraction) | (wt. fraction) | (wt. fraction) | (wt. fraction) |
| 1 | Initiator 1 mol % | 0.39 | 0.59 | 0 | 0.02 |
| 2 | Initiator 2 mol %, | 0.38 | 0.58 | 0 | 0.04 |
| | Crosslinker 0 mol % | | | | |
| 3 | Crosslinker 2.5 mol % | 0.37 | 0.55 | 0.04 | 0.04 |
| 4 | Crosslinker 5 mol % | 0.35 | 0.53 | 0.08 | 0.04 |
| 5 | Crosslinker 10 mol % | 0.32 | 0.48 | 0.15 | 0.04 |

FIG. 2 shows the GPC traces of samples with different initiator contents and different UV exposure times, compared to the neat triblock sample. The response was normalized by the signal of the triblock, which was used at the same concentration for all formulations. The triblock was detected at ˜21 minutes indicating a molecular weight of ˜66,000 g/mol against PMMA standards. The broader signal observed for the formulations, overlapping with the triblock, is attributed to the PnBA polymerized in situ. Considering the entanglement molecular weight for PnBA of ˜28,000 g/mol, this verified the formation of a physically entangled secondary PnBA network in the system.

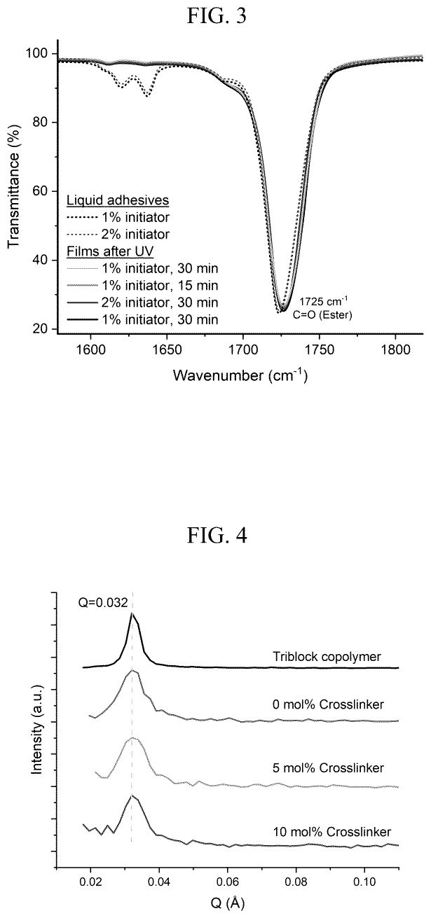

FIG. 3 depicts the FTIR spectra of the liquid adhesive mixture (before photopolymerization) and the respective films (after photopolymerization) for samples with 1 mol % and 2 mol % initiator, exposed to UV for 15 or 30 min. The depletion of the C═C stretching modes at 1619 and 1636 cm⁻¹ in the samples after UV exposure indicate monomer consumption and confirms the completion of the photopolymerization reaction.

Subsequently, to assess the effects of crosslinker content, all crosslinked samples were tested with 2 mol % initiator. A similar effect was observed in FTIR for samples with fixed initiator content and varying amount of crosslinker (2.5 mol %, 5 mol %, and 10 mol % as function of the BA monomer concentration), indicating quantitative reaction for all samples cured for 15 or 30 min. To confirm the absence of unreacted monomers, polymerized samples were stored at 40° C. for 24 h and mass changes were recorded. Gravimetric measurements showed a mass loss of 0.2 to 0.35 wt % after 24 h, indicating full conversion. The mass of the samples remained stable for another 3 days at room temperature (˜23° C.) following the 24-hour treatment, confirming the effectiveness of the photopolymerization reaction. Additionally, thermogravimetric analysis (TGA) was performed immediately after UV for the sample containing 2 mol % initiator and 5 mol % crosslinker, exposed to UV for 15 min. The TGA with a heating rate of 2° C./min revealed a 0.44% mass loss up to 145° C., which corresponds to the boiling point of the monomer BA. A more significant mass loss, observed by a change in slope, takes place above around 165° C. due to thermal degradation of the polymer. The initial minor mass loss corroborates the minimal loss of volatile and unreacted compounds after photopolymerization of the secondary network, observed in the gravimetric analysis through post-treatment at 40° C.; TGA confirms stability of the adhesive even at higher temperatures (up to ˜165° C.).

Subsequently, an elution test was conducted to confirm the formation of a network upon addition of the crosslinker EGDMA to the initial mixture of triblock, BA, and initiator. A polymerized sample (5 mol % crosslinker, 15 min UV) was immersed in tetrahydrofuran (THF) for ˜30 min and the eluted material was analyzed using NMR spectroscopy. The analysis revealed the absence of BA in the eluted material, as determined by the comparison with the pure BA spectrum which shows the vinyl hydrogen peaks. When comparing the spectrum of the eluted material with that of the original triblock there was almost complete overlap. Analyzing the NMR spectrum it was concluded that ˜75 wt % of the leached material is triblock and ˜25 wt % can be attributed to the presence of poly(butyl acrylate) oligomers that were not integrated into the crosslinked PnBA network. The washed crosslinked sample was then dried at room temperature for 48 h, resulting in a final weight of approximately 48% of the initial sample weight. This mass reduction also suggests the removal of the triblock (40%) and a small fraction of non-crosslinked PnBA.

Previous studies of PMMA-b-PnBA-b-PMMA and other symmetric triblock systems dissolved in midblock selective solvents report microphase separation into spherical or cylindrical structures. For example, in a PMMA-b-PnBA-b-PMMA system in 2-ethyl-1-hexanol (midblock-block-selective solvent at low temperatures), the transition between these morphologies occurs for a PMMA weight fraction ranging from 0.07 to 0.24. Comparably, the triblock used in the present study has two PMMA segments with weight fraction of 0.15 (0.3 total PMMA weight fraction). However, the morphology within systems can vary, as the interaction with the solvent is the driving force for phase separation, and is determined by polymer concentration and processing history, such as annealing. Neat triblock samples with varying concentration of end and middle blocks, and triblock samples with added homopolymer show the same phase transition, indicating that, to some extent, can be considered as the total PnBA content in the modified samples as a shift in composition while keeping the Flory-Huggins segment interaction parameter and chain length similar. This corresponds to a horizontal shift in a phase diagram of the Flory-Huggins segment interaction parameter as a function of system composition.

To evaluate the resultant morphology following in situ polymerization of the PnBA network, small-angle X-ray scattering (SAXS) and transmission electron microscopy (TEM) were performed. FIG. 4 shows the 1D scattering profiles for the neat triblock copolymer and samples with varying crosslinker contents, 0 mol %, 5 mol %, and 10 mol %, respectively. The scattering profiles were shifted vertically for clarity. The characteristic peak at a scattering vector Q=0.032 Å arises from the periodicity of the microphase domains, reflecting the average d spacing (d=2πc/Q) of ˜19.6 nm between scattering centers for all samples. Comparing the 1D scattering profile of the control triblock and the dual-network samples, the primary peak remains unchanged, yet the dual-network samples present a broader peak, indicating a broader distribution. The scattering pattern for higher Q values, which provides information on the form factor of the domains, does not reveal a higher order of organization.

TEM analysis of neat triblock copolymer and different dual-network samples reveals distinct morphology depending on the crosslinker content. In the TEM micrographs, the darker regions correspond to the PMMA blocks, which were stained with phosphotungstic acid (PTA) for better contrast.

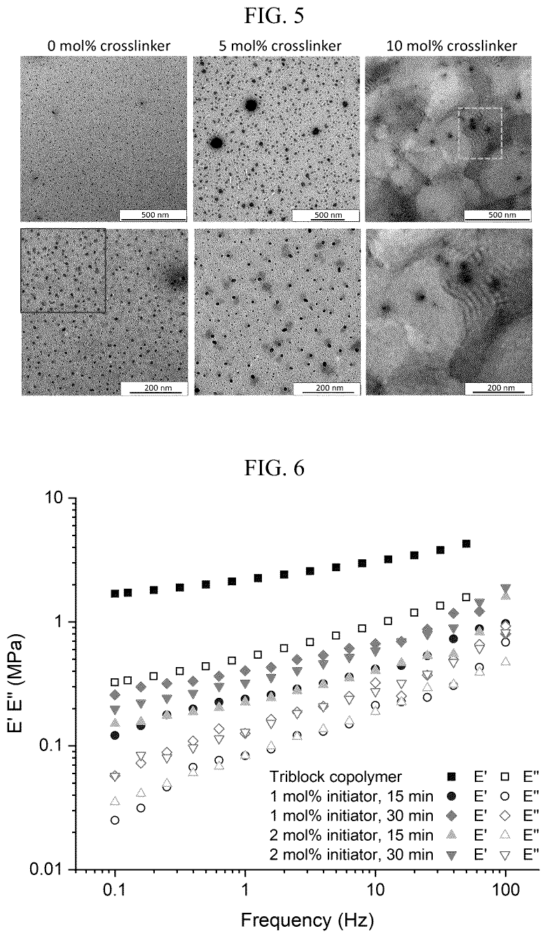

FIG. 5 shows TEM images of the dual-network samples with varying crosslinker concentrations. In the sample without crosslinker (0 mol %), the spherical PMMA domains are relatively small and uniformly distributed. The inset in red shows an example of microdomain contours used to calculate object diameters and mean nearest neighbor distances. For this sample, the mean object diameter was ˜7.0 nm, and the mean spacing center-to-center between microdomains was ˜14.6 nm.

At 5 mol % crosslinker content in FIG. 5, the microdomains maintain their spherical morphology, but some larger domains can be observed at lower magnification (upper image). This suggests that crosslinking of the PnBA homopolymer leads to some degree of aggregation or domain coarsening. The calculated mean object diameter for the higher magnification (bottom image) was ˜6.4 nm and mean nearest neighbor distance was ˜17.7 nm (excluding larger domains observed at lower magnification). The sample presents a broader size distribution, with domains reaching up to 18 nm, compared to the sample without crosslinker.

Finally, with 10 mol % crosslinker, there is a notable change in the morphology. Fewer spherical domains are present, and some regions (highlighted in orange) resemble a cylindrical phase distribution. These different regions are dispersed in a matrix that does not have a distinct phase behavior, potentially composed mostly of the crosslinked PnBA phase in a random, amorphous state. Manual measurements of the spherical domains indicate diameters of around 18 nm. The spacings of samples with 0 mol % and 5 mol % crosslinker (14 and 17 nm) as recorded by TEM are in the same range as measured using SAXS.

It was hypothesized that the sample with 0 mol % crosslinker exhibits a homogeneously distributed spherical morphology because the non-crosslinked PnBA phase can occupy the PnBA-block domain of the triblock copolymer. This allows for better mixing and a more uniform structure. When comparing the system without crosslinker to the one with 5 mol % crosslinker, a shift in self-assembly behavior was observed, leading to the formation of both large and small populations of spherical PMMA domains. In the low crosslinked system, the PnBA phase has reduced mobility, which may limit the penetration into the PnBA block domains. As the PnBA component becomes less miscible due to the increase in the crosslinking density, the midblock chains are restricted from stretching freely, causing the microdomains to separate further or aggregate, as seen in the sample with 10 mol % crosslinker.

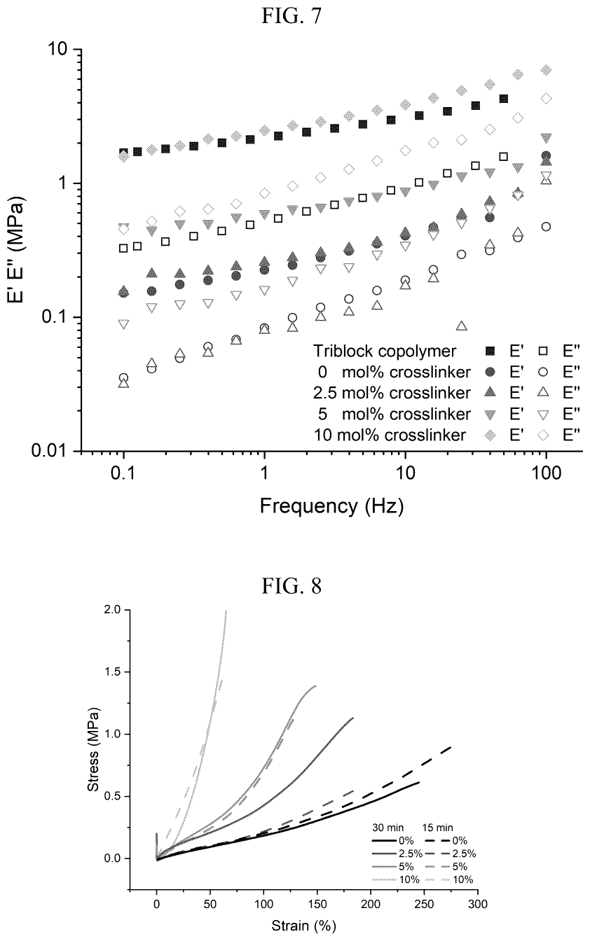

FIGS. 6-9 shows the mechanical characterization of UV-cured cast films of approximately 1 mm thickness across various formulations. FIG. 6 and FIG. 7 show frequency sweep DMA results for samples with and without the crosslinker, respectively. FIG. 6, the neat triblock copolymer as well as all the samples with the secondary PnBA network in absence of crosslinker behave as an elastic solid, with E′>>E″, verifying that the PMMA domains observed in TEM are predominantly bridged, therefore dominating the mechanical response contribution of the triblock copolymer network. Considering that the second network of PnBA is physically entangled, both the storage (E′) and loss (E″) moduli for all formulations (E′˜0.2 to 0.6 MPa and E″˜0.06 to 0.13 MPa at 1 Hz) are lower than the neat triblock (E′˜2.12 and E″˜0.48 MPa at 1 Hz). This can be explained by the fact that the PnBA dilutes the PMMA content, compared to the neat triblock, reducing the number of hard domains that act as physical, dynamic crosslinks to dissipate energy, reducing the overall mechanical response and creating a softer material.

Upon introducing different concentrations of crosslinker while keeping the UV irradiation at a constant 15 min, an increased response in both storage and loss moduli were observed (at 1 Hz, E′ increases from 0.2 to 2.8 MPa as increase the crosslinker from 0 to 10 mol %, while E″ increases from 0.07 to 0.84 MPa) (FIG. 7). The sample with the highest amount of crosslinker, 10 mol %, exhibits storage moduli comparable to that of the neat triblock, along with higher loss moduli, indicating more dissipation in the stiffer network. The strain hardening observed for all samples in DMA measurements is consistent with previously reported behavior for ABA triblock copolymers and systems combining triblocks with their respective mid-block homopolymer. This effect is attributed to the initial extension of the mid-block bridging chains that occur before the PMMA glassy domains are disrupted, which creates a higher effective modulus at higher deformation.

This response is particularly interesting for adhesive applications in textile-based composites, which exhibit anisotropic, non-linear mechanical behavior. The strain-hardening in textiles at high deformations arise from architecture-dependent mechanisms, beginning with thread tensioning followed by reinforcement through interlocking designs. This highlights the importance of molecular design of the adhesive to match the mechanical properties of the intended substrate and effectively control strain hardening, in particular focusing on the balance between crosslinking density and the role of soft mid-block of the triblock copolymer.

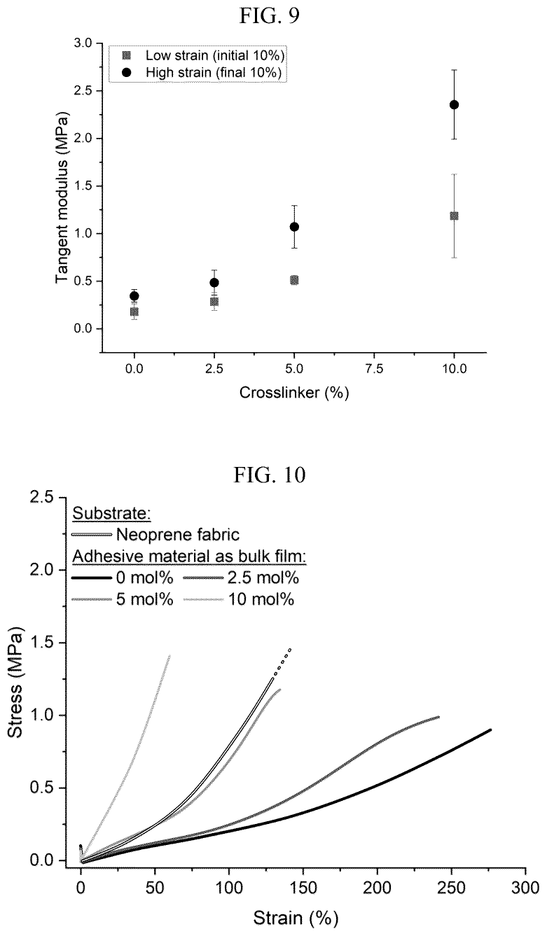

The trends observed in DMA results align with tensile test data represented in FIG. 8 where increasing crosslinker content correlates to higher failure stress but lower strain at failure for both UV times of 15 and 30 min. It is important to note that, for the tensile tests of the bulk material, the samples failed at the grip, so the maximum values reported in FIG. 8 may not fully represent the failure performance of the samples. Lastly, in FIG. 9, the Tangent Moduli obtained from the stress-strain curves at low and high strain, as a function of crosslinker content are presented. These results show a trade-off between the stiffness and stretchability of the dual network, by adding varying crosslinker contents and shifting from a physically to a chemically crosslinked network. The strain-hardening effect observed is particularly interesting for adhesive applications in textile-based composites, which exhibit anisotropic, non-linear mechanical behavior. The additional structural integrity obtained by the highly crosslinked samples leads to higher stiffness but also reduces energy dissipation and the ability to undergo larger deformations before failure. Considering this wide range of mechanical responses, it is possible to adjust the formulation to match the substrate's mechanical properties.

Given the tunability of its mechanical properties, the adhesive's applicability for neoprene fabric—a complex, multilayered composite material consisting of outer fabric layers around neoprene foam, which presents unique challenges for bonding technologies, was evaluated. In its application, neoprene fabric must offer flexibility, stretchability, durability, and resilience to environmental factors. However, its surface irregularities and porosity, combined with the need for the adhesive to withstand large deformations without delamination, make achieving strong adhesion particularly challenging.

FIG. 10 shows the stress-strain curves of the formulations with varying crosslinker content, and UV exposure 15 min, alongside the mechanical response of a commercial neoprene fabric sample up to ˜100% strain. Notably, the formulation with 5 mol % crosslinker exhibited a mechanical behavior closely matching that of the neoprene substrate and was selected as a candidate for further testing as an adhesive.

In addition to material properties, the geometry of seam construction plays a crucial role in determining the performance and durability of joints between adherends. By exploring different bonding methods, such as applying the adhesive material only in the center between the adherents (glue), or applying it as a layer on the outer region of the joint (seam), and their combination, how these factors impact the overall strength and stretchability of neoprene fabric joints were assessed.

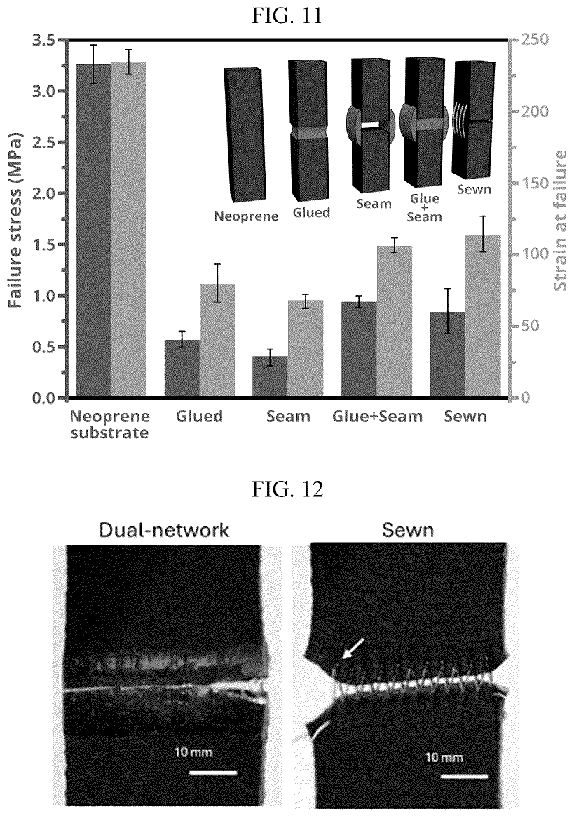

FIG. 11 shows the failure stress and strain at failure for the neoprene substrate and joints bonded using different methods: the formulation with 5 mol % crosslinker used as glue between two pieces of neoprene; formulation used as a seam, applied only to the outer fabric on the bonding region; formulation used as both glue and seam; and a sewn sample using zig zag stitch with a polyester thread as reference of current bonding method. The material was applied to both sides of the substrate using a syringe and a custom 3D printed nozzle, ensuring controlled seam width of 10 mm and maximal thickness of 1 mm along the samples. Schematic representations of all bonding methods are provided. The jointless neoprene has high failure stress of 3.25 MPa and strain at failure 235%. Performance of neoprene joints varied depending on the bonding method. Both application of the adhesive formulation as glue or seam yielded joints resisting 0.57 and 0.39 MPa, and strain of 80% and 67%, respectively.

Using the formulation as both glue and seam improves the joint (˜0.94 MPa stress and ˜106% strain) and yields comparable results to the sewn sample (˜0.84 MPa stress and ˜114% strain). Additional advantages of the dual-network formulation are represented in FIG. 12 by photos of both seams shortly before they start to fail: while the sewn sample quickly opens a large gap between the neoprene pieces, the punctures where the threads pass over are points of failure and opening—detrimental in cases where resistance to water penetration is necessary, for example. The dual-network adhesive sample, on the other hand, provides sealing up to large deformations and a more homogeneous deformation due to the outer seam shape, which creates a small gradient effect—thicker and stiffer at the center of the joint between the neoprene pieces, and thinner moving away from the seam and integrating to the substrate. Moreover, there is no delamination from the fabric, since the adhesive allows for penetration into the fabric prior to curing.

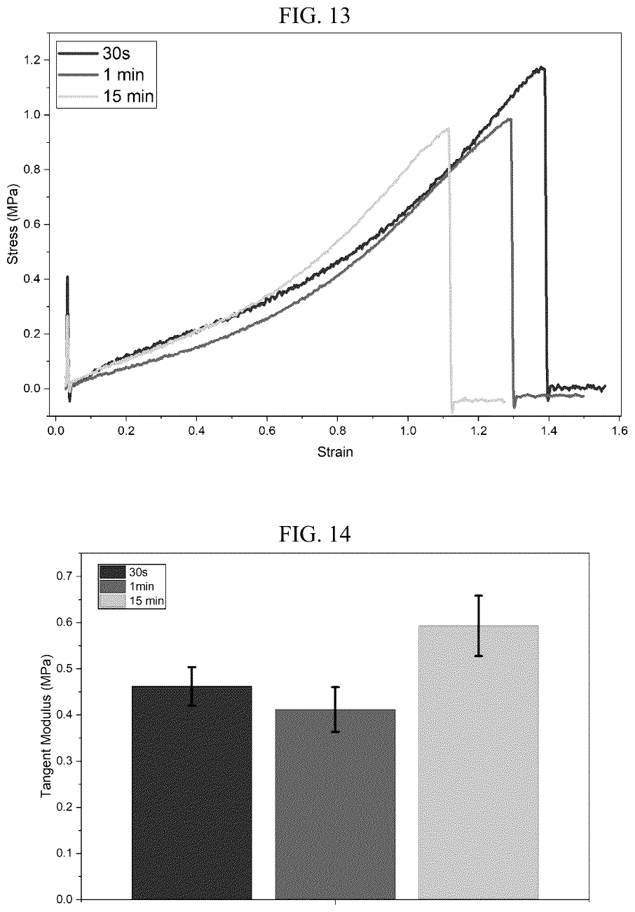

Effect of curing time was also assessed. For experiments related to curing time, the PMMA-PnBA-PMMA triblock copolymer in n-butyl acrylate with 5 mol % EGDMA and 2 mol % initiator) was used. The cast films had a thickness of 0.7 to 1 millimeter, and were UV-cured for times of 30 seconds, 1 minute, and 15 minutes (7.5 to 9 mW cm²). Representative stress-strain curves from tensile testing on the bulk films are shown in FIG. 13, and illustrate the mechanical response as a function of UV exposure time. A short curing time of 30 seconds provided satisfactory materials. It is noted that in the tensile tests, the samples failed at the grip, so the maximum values reported may not fully represent the failure performance. Tangent modulus at low strain as a function of curing time is shown in FIG. 14. It is noted that only a minimal increase in modulus was observed when a curing time of 15 minutes was used compared to samples cured for 30 second and 1 minute. These results indicate that full curing can be achieved in short times (e.g., 30 second to 1 minute) without significant differences in mechanical properties compared to longer-cured samples.

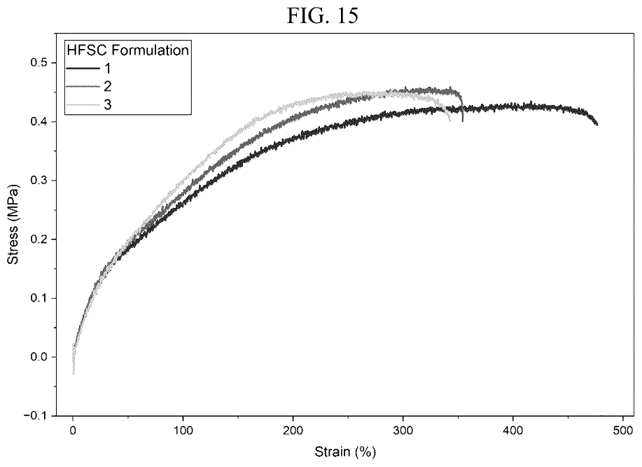

Compositions were also tested where the PMMA-PnBA-PMMA triblock copolymer was substituted with a hydrogenated styrene farnesene copolymer (HSFC; commercially available as SF904 under the “Bio-based” line of SEPTON from Kuraray). The composition was formulated using a 60:40 weight ratio of HSFC:n-butyl acrylate, 5 mole percent EGDMA crosslinker (relative to n-butyl acrylate), and 2 mole percent of photoinitiator (IRGACURE 819; mole percent relative to the moles of reactive groups). The composition was cast as a film having a thickness of about 1 millimeter, and UV-cured for 1 minute. Representative stress-strain curves from tensile testing on the bulk films are shown in FIG. 15, where the samples noted as 1, 2, and 3 are replicates of the same formulation. The results showed a lower modulus relative to the acrylate systems, but high extensibility prior to failure. Thus the HSFC copolymer may represent a bio-based alternative to the acrylate compositions described.

Experimental details follow.

Materials: ABA Triblock copolymers having poly(methyl methacrylate) (PMMA) end blocks and poly(n-butyl acrylate) (PnBA) mid-block (KURARITY, obtained from Kuraray Co., Ltd) were used as received. Butyl acrylate (BA) monomer and ethylene glycol dimethacrylate (EGDMA) crosslinker were purchased from Sigma Aldrich. The photoactive photoinitiator Irgacure 819 was acquired from Ciba-Giegy Specialty Chemical Divisions. BA and EGDMA were passed through basic alumina (active, 32-63 μm, Sorbtech) to remove the inhibitor before polymerization. The photoinitiator was used as received. A neoprene fabric substrate (Sewswank Store) with 3 mm thickness was used for adhesion tests.

Sample fabrication: A mixture of triblock pellets and butyl acrylate (BA) monomer (M1) was prepared at least 24 hour prior to use, with an initial composition of 40 wt % triblock polymer and 60 wt % BA. Higher concentrations of triblock in BA were not explored due to substantial increase in solution viscosity, which adversely affected processability. The crosslinker and initiator were subsequently added to M1 and mixed homogeneously using a speed mixer (DAC-330-100 Pro). The amount of crosslinker added was calculated as a fraction of the BA molar content (2.5 mol %, 5 mol %, 10 mol %) while the amount of initiator was calculated based on the number of vinyl groups in each sample (1 mol % or 2 mol %). For example, a sample with 2 mol % initiator contains (0.02×(mol BA+2×mol EGDMA)) mol initiator. To verify the effects of initiator content, samples without crosslinker (0 mol %) were tested with either 1 mol % or 2 mol % initiator. To assess the effects of crosslinker, all crosslinked samples were tested with 2 mol % initiator.

The formulation was cast into molds with a polytetrafluoroethylene (PTFE, Teflon) bottom and leveled using a glass slide to achieve a uniform thickness and smooth surface for preparing “bulk samples”. For the adhesion experiments, the material was applied to the adherend substrates using a syringe and a 3D printed polylactic acid (PLA) nozzle, ensuring controlled seam width (10 mm) and max thickness (1 mm) along 40 mm wide neoprene samples, applied on both sides. The materials were cured under UV-light for 5, 15 or 30 minutes using a near UV illumination system equipped with an Arc Mercury lamp 500 W (Newport #6285=USHIO USH-508SA), with the intensity set to 7.5 to 9 mW/cm². For gravimetric measurements, one set of samples was placed in the oven at 40° C. overnight and weighed before and after the post-baking treatment.

### Characterization

Gel permeation chromatography (GPC) was conducted in an Agilent Technologies 12160 Infinity series system with two 5 μm mixed-D columns, a 5 μm guard column, a PL Gel 5 μm analytical mixed-D column, and a refractive index (RI) detector (HP1047A); tetrahydrofuran (THF) was used as eluent with a flow rate of 1.0 ml/min, PMMA standards were used for the calibration.

Infrared spectra (IR) were recorded using 64 scans, in a PerkinElmer Spectrum 100 FT-IR spectrometer in ATR mode using a diamond ATR element.

Thermogravimetric analysis (TGA) was performed using a TGA Q50 from TA Instruments. Samples were heated from room temperature to 250° C. at a heating rate of 2° C./min under nitrogen. Thermogravimetric mass loss (TG) and mass loss derivative curve (DTG) were recorded as a function of time and temperature.

Small-Angle X-ray scattering (SAXS) experiments were performed on the cast “bulk films” of approximately 1 mm thickness using a Rigaku SmartLab X-ray Diffractometer with a CuKα source (λ=0.159 nm). Scattering vector range covered a range from q=0 to 0.3 using a beam of 3 kW. Data was collected in a HyPix3000 Hybrid Pixel Array detector.

Transmission electron microscopy (TEM) sample preparation was performed by cutting ultrathin sections (ca. 90 nm thick) with a glass knife on a Leica Ultracut UCT microtome under cryogenic conditions at −90° C. Sections were collected on 400 mesh carbon coated copper grids, and the PMMA regions were subsequently stained using an aqueous solution of 2 wt % phosphotungstic acid (PTA) and 2 wt % benzyl alcohol at room temperature for 10 minutes. Stained samples were imaged in a transmission electron microscope JEOL JEM-2200FS. TEM images were analyzed using a custom python code and OpenCV python library for denoising, thresholding and object selection. Scikit-learn was used for nearest neighbor calculations.

Dynamic Mechanical analysis (DMA) of the cured adhesive formulations was conducted with a Discovery DMA 850 (TA Instruments) at room temperature. Rectangular samples with a thickness between 0.5 and 1 mm and width of 5 mm were placed between the tension clamps and storage moduli (E′), loss moduli (E″), and tan δ (=E″/E′) were measured with varying frequency from 0.1 to 100 Hz at fixed strain 0.1% and preload force 0.01 N.

Uniaxial tensile testing was conducted using an Instron 68TM-5 with an advanced video extensometer (AVE 2) for precise digital strain measurement. Samples underwent controlled deformation at 305 mm/s until failure. Bulk samples were cut into rectangular samples with 10 mm width, thickness ranging from 0.6 to 1 mm, and measured using a gauge length of 50 mm.

Neoprene fabric substrates (70% Neoprene, 30% Nylon) were purchased from Macro International. A control sample was prepared by sewing two pieces of neoprene using a zig-zag stitch with polyester thread in a Singer Confidence 7470 sewing machine.

This disclosure further encompasses the following aspects.

Aspect 1: A photocurable adhesive composition comprising: an ABA triblock copolymer, wherein the A blocks are capable of self-assembling into rigid domains and the B block provides a soft matrix; a polymerizable monomer capable of selectively solubilizing the B block of the ABA triblock copolymer; a photoinitiator capable of initiating polymerization when irradiated with ultraviolet light; and optionally, a crosslinker.

Aspect 2: The photocurable composition of aspect 1, wherein the A blocks each comprise a poly(C₁₋₃ alkyl methacrylate) and the B block comprises a poly(C₄₋₁₂ alkyl methacrylate); or the A blocks each comprise a poly(styrene) and the B block comprises a polyolefin, preferably polybutadiene or polyisoprene.

Aspect 3: The photocurable adhesive composition of aspect 1 or 2, wherein the polymerizable monomer has a chemical structure corresponding to a monomer from which the B block of the ABA triblock copolymer is derived.

Aspect 4: The photocurable adhesive composition of any of aspects 1 to 3, wherein the ABA triblock copolymer is a poly(methyl methacrylate)-b-poly(n-butyl acrylate)-b-poly(methyl methacrylate) triblock copolymer; and the polymerizable monomer comprises n-butyl acrylate.

Aspect 5: The photocurable adhesive composition of any of aspects 1 to 4, wherein the photoinitiator is a photoradical generator.

Aspect 6: The photocurable adhesive composition of any of aspects 1 to 5, wherein the photoinitiator is a photoradical generator capable of absorbing light in the range of 300 to 400 nanometers.

Aspect 7: The photocurable adhesive composition of any of aspects 1 to 6, wherein the photoinitiator comprises a bisacylaphosphine oxide.

Aspect 8: The photocurable adhesive composition of any of aspects 1 to 7, wherein the photoinitiator comprises phenylbis(2,4,6-trimethylbenzoyl)phosphine oxide.

Aspect 9: The photocurable adhesive composition of any of aspects 1 to 8, wherein the crosslinker in present.

Aspect 10: The photocurable adhesive composition of aspect 9, wherein the crosslinker comprises at least two free-radically polymerizable groups, preferably comprising ethylenic unsaturation, more preferably comprising (meth)acrylate groups.

Aspect 11: The photocurable adhesive composition of aspect 9 or 10, wherein the crosslinker comprises a glycol dimethacrylate, preferably ethylene glycol dimethacrylate.

Aspect 12: The photocurable adhesive composition of any of aspects 1 to 11, comprising: 20 to 40 weight percent of the ABA triblock copolymer; 40 to 80 weight percent of the polymerizable monomer; 0.05 to 5 weight percent of the photoinitiator; and 0 to 20 weight percent of the crosslinker; wherein weight percent of each component is based on the total weight of the composition.

Aspect 13: The photocurable adhesive composition of any of aspects 1 to 11, comprising: 20 to 40 weight percent of the ABA triblock copolymer; 40 to 80 weight percent of the polymerizable monomer; 0.05 to 5 weight percent of the photoinitiator; and 2 to 20 weight percent of the crosslinker; wherein weight percent of each component is based on the total weight of the composition.

Aspect 14: The photocurable adhesive composition of aspect 12 or 13, wherein the ABA triblock copolymer is a poly(methyl methacrylate)-b-poly(n-butyl acrylate)-b-poly(methyl methacrylate) triblock copolymer; the polymerizable monomer comprises n-butyl acrylate; the photoinitiator is a photoradical generator capable of absorbing light in the range of 300 to 400 nanometers; and when present, the crosslinker comprises at least two free-radically polymerizable groups, preferably comprising ethylenic unsaturation.

Aspect 15: The photocurable adhesive composition of any of aspects 1 to 14, wherein the composition is free of an organic solvent.

Aspect 16: A cured adhesive formed from the photocurable adhesive composition of any of aspects 1 to 15.

Aspect 17: The cured adhesive of aspect 15, wherein the cured adhesive exhibits a Young's modulus of 0.15 to 1.2 MPa; and a stretchability of at least 50%.

Aspect 18: A method of bonding, the method comprising: applying the photocurable adhesive composition of any of aspects 1 to 15 to at least a portion of a surface of a first substrate; affixing the first substrate to a second substrate; and exposing the photocurable adhesive composition to ultraviolet radiation to initiate curing.

Aspect 19: The method of aspect 18, wherein the first substrate and the second substrate are flexible substrates, preferably wherein the first substrate and the second substrate are textiles, more preferably wherein the first substrate and the second substrate each comprise neoprene fabric.

Aspect 20: The method of any of aspects 18 to 19, wherein the photocurable adhesive comprises 20 to 40 weight percent of the ABA triblock copolymer; 40 to 80 weight percent of the polymerizable monomer; 0.05 to 5 weight percent of the photoinitiator; and 2 to 15 weight percent of the crosslinker; wherein weight percent of each component is based on the total weight of the composition.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the compound or group, including those of any substituents.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A photocurable adhesive composition comprising:
an ABA triblock copolymer, wherein the A blocks are capable of self-assembling into rigid domains and the B block provides a soft matrix;
a polymerizable monomer capable of selectively solubilizing the B block of the ABA triblock copolymer;
a photoinitiator capable of initiating polymerization when irradiated with ultraviolet light; and
optionally, a crosslinker.

2. The photocurable composition of claim 1, wherein
the A blocks each comprise a poly(C₁₋₃ alkyl methacrylate) and the B block comprises a poly(C₄₋₁₂ alkyl methacrylate); or
the A blocks each comprise a poly(styrene) and the B block comprises a polyolefin.

3. The photocurable adhesive composition of claim 1, wherein the polymerizable monomer has a chemical structure corresponding to a monomer from which the B block of the ABA triblock copolymer is derived.

4. The photocurable adhesive composition of claim 1, wherein
the ABA triblock copolymer is a poly(methyl methacrylate)-b-poly(n-butyl acrylate)-b-poly(methyl methacrylate) triblock copolymer; and
the polymerizable monomer comprises n-butyl acrylate.

5. The photocurable adhesive composition of claim 1, wherein
the ABA triblock copolymer is a poly(styrene)-b-poly(butadiene)-b-poly(styrene) triblock copolymer, a poly(styrene)-b-poly(isoprene)-b-poly(styrene) triblock copolymer, a poly(styrene)-b-poly(ethylene-butylene)-b-poly(styrene) triblock copolymer, a poly(styrene)-b-poly(ethylene-propylene)-b-poly(styrene) triblock copolymer, or a poly(styrene)-b-poly(hydrogenated farnesene)-b-poly(styrene) triblock copolymer; and
the polymerizable monomer comprises an butadiene, isoprene, or a combination thereof.

6. The photocurable adhesive composition of claim 1, wherein the photoinitiator is a photoradical generator capable of absorbing light in the range of 300 to 400 nanometers.

7. The photocurable adhesive composition of claim 1, wherein the photoinitiator comprises a bisacylphosphine oxide or phenylbis(2,4,6-trimethylbenzoyl)phosphine oxide.

8. The photocurable adhesive composition of claim 1, wherein the crosslinker in present.

9. The photocurable adhesive composition of claim 8, wherein the crosslinker comprises at least two free-radically polymerizable groups.

10. The photocurable adhesive composition of claim 8, wherein the crosslinker comprises a glycol dimethacrylate.

11. The photocurable adhesive composition of claim 1, comprising:
20 to 40 weight percent of the ABA triblock copolymer;
40 to 80 weight percent of the polymerizable monomer;
0.05 to 5 weight percent of the photoinitiator; and
0 to 20 weight percent of the crosslinker;
wherein weight percent of each component is based on the total weight of the composition.

12. The photocurable adhesive composition of claim 1, comprising:
20 to 40 weight percent of the ABA triblock copolymer;
40 to 80 weight percent of the polymerizable monomer;
0.05 to 5 weight percent of the photoinitiator; and
2 to 20 weight percent of the crosslinker;
wherein weight percent of each component is based on the total weight of the composition.

13. The photocurable adhesive composition of claim 12, wherein
the ABA triblock copolymer is a poly(methyl methacrylate)-b-poly(n-butyl acrylate)-b-poly(methyl methacrylate) triblock copolymer;
the polymerizable monomer comprises n-butyl acrylate;
the photoinitiator is a photoradical generator capable of absorbing light in the range of 300 to 400 nanometers; and
when present, the crosslinker comprises at least two free-radically polymerizable groups.

14. The photocurable adhesive composition of claim 1, wherein the composition is free of an organic solvent.

15. A cured adhesive formed from the photocurable adhesive composition of claim 1.

16. The cured adhesive of claim 15, wherein the cured adhesive exhibits
a Young's modulus of 0.15 to 1.2 MPa; and
a stretchability of at least 50%.

17. A method of bonding, the method comprising:
applying the photocurable adhesive composition of claim 1 to at least a portion of a surface of a first substrate;
affixing the first substrate to a second substrate; and
exposing the photocurable adhesive composition to ultraviolet radiation to initiate curing.

18. The method of claim 17, wherein the first substrate and the second substrate are flexible substrates.

19. The method of claim 17, wherein the first substrate and the second substrate are each flexible fabric substrates comprising neoprene, polyurethane, thermoplastic polyurethane, or ethylene-vinyl acetate.

20. The method of claim 17, wherein the photocurable adhesive composition comprises
20 to 40 weight percent of the ABA triblock copolymer;
40 to 80 weight percent of the polymerizable monomer;
0.05 to 5 weight percent of the photoinitiator; and
2 to 15 weight percent of the crosslinker;
wherein weight percent of each component is based on the total weight of the composition.
